(19) United States
(12) Patent Application Publication
(10) Pub. No.: US 2008/0247515 A1
(43) Pub. Date: Oct. 9, 2008

(54) Rotor

(76) Inventors: Ulrich Probst, Aachen (DE); Hans Kammerling, Eschweiler (DE); Tadeusz Kozielewski, Duren (DE); Heidi Straatmann, Julich (DE); Peter Rottlander, Koln (DE); Thomas Koppitz, Aachen (DE)

Correspondence Address: K.F. ROSS P.C., 5683 RIVERDALE AVENUE, SUITE 203 BOX 900, BRONX, NY, 10471-0900, US

(21) Appl. No.: 10/586,201

(22) PCT Filed: Jan. 8, 2005
(86) PCT No.: PCT/DE2005/000015

§ 371 Date: Jun. 23, 2008

(30) Foreign Application Priority Data
Jan. 16, 2004 (DE) 102004002326.3

(51) Int. Cl. G21K 1/04

(52) U.S. Cl. 378/160

(57) ABSTRACT

The invention concerns a rotor combining the advantages of a single-piece wheel, which, when it is operating, only exhibits a slight and constant variation in shape (expansion shift) in the guiding region of its path, with those of a rimmed rotor with spokes, enabling, by virtue of its light weight, the bearings to be easily arranged. Further, because of its tendency to exhibit a tensile stress higher than a bending load, the rotor provides for a wide selection of rotor materials. The rotor has at least one segment arranged on the hub, enclosing at least a closed recess. A preferred embodiment concerns a rotor comprising at least three rotor segments uniformly distributed, said segments having each two recesses, such that the regions of materials surrounding them are in the form of three spokes arranged substantially parallel. The inventive rotor is particularly suitable for receiving graphite crystals, in the form or a vibrating disc for a back-scattering spectrometer.

The invention relates to a rotor, especially a rotor carrying optical, magnetic and/or mechanical sensors. The invention furthermore relates to the use of such a rotor as a chopper wheel in a backscatter spectrometer.

### PRIOR ART

A rotating part of an electrical machine is generally referred to as a rotor. Motors and prime movers are especially understood to be the part connected to a shaft and possibly carrying the components that are needed for energy conversion. Such parts include the moving vanes in turbo engines or the coils in electrical machines. Rotors are, for example, used as choppers in locking or backscatter devices, and may incorporate various active elements. Within the scope of this invention, such active elements are understood to include optical, magnetic or mechanical sensors, filters, reflectors or flows from moderating media.

In a backscatter spectrometer, the per se fine energy resolution causes an unfavorable lack of neutron intensity. To increase this intensity, the neutron beam may be reflected by crystals moving very fast. At sufficiently high speeds of the crystals, e.g. 300 m/s, phase-space transformation occurs, whereby neutrons that are too slow are accelerated and neutrons that are too fast are decelerated. Thus, neutron intensity may be increased appreciably.

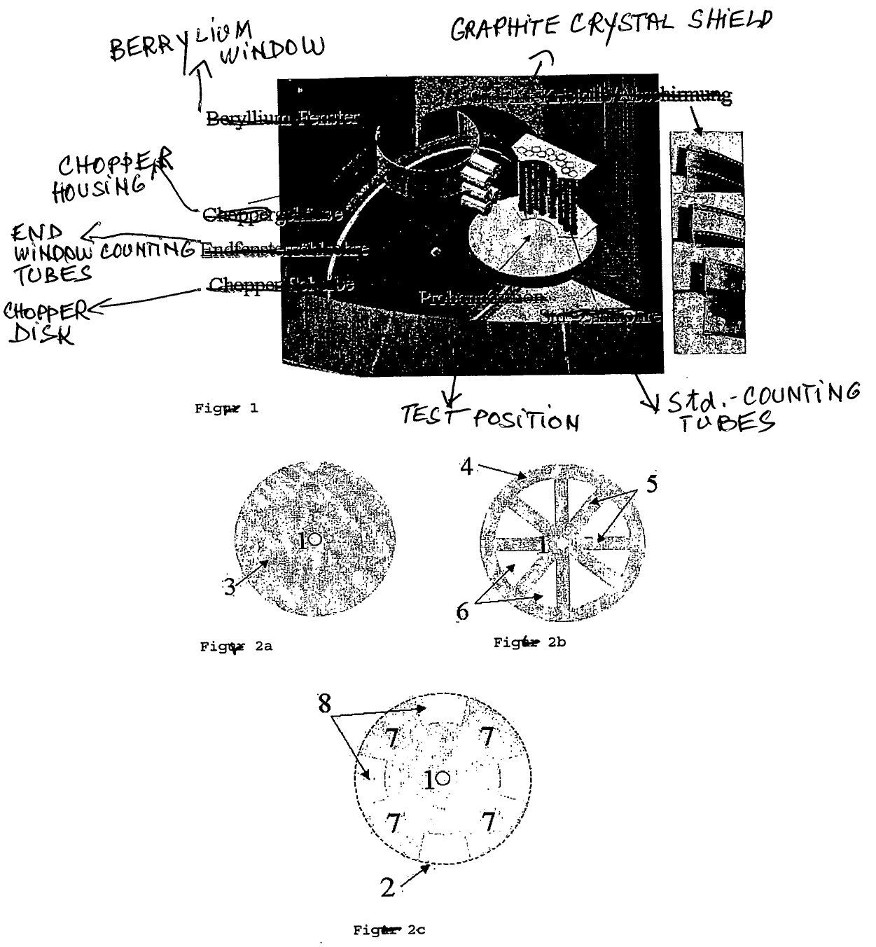

A backscatter spectrometer (RSSM) for FRM-II in Munich uses, e.g. a rotor, a PST chopper, here a massive circular chopper disk. The outer edge is divided into six equally large areas. Every other area is provided with crystals (see FIG. 1). The areas of the chopper disk having crystals (crystal-holding) have a greater radius than do the areas without crystals. The areas without crystals in this chopper disk thereby assume the function of windows in order to allow neutron beams to pass through. With usual backscatter spectrometers, the maximum chopper disk diameter is about 130 cm due to the average neutron energy and the actual geometry of the device. For a crystal speed of about 300 m/s, the chopper wheel must rotate with a speed of about 4800 RPM.

Very high strains and corresponding material load appear due to the high centrifugal force. Constructing a suitable rotor (chopper) thus becomes very costly, since a similarly high mechanical load capacity is needed and it should have slight and primarily uniform change of shape at the perimeter at a minimum net weight.

As an alternative to a solid, single-piece disk, a spoked wheel (rim-spoked rotor) is also conceivable. A spoked wheel advantageously weighs noticeably less than a solid disk. The spokes advantageously absorb radial stress, while the rims are able to absorb the angular stress. As a disadvantage, it was found that the unavoidable maximum bending stress is situated only slightly below the fatigue properties of the material being used.

By using active elements and/or other passive elements that are carried in circular paths, physical particles, other than neutrons, e.g. sand, powder or gases, may be controlled or influenced.

The requirements of a chopper wheel inside a backscatter spectrometer are generally also applicable to rotors designed for high rotational speeds.

### PROBLEM AND SOLUTION

The object of the invention is to create a light-weight rotor, especially carrying active elements, having at high rotational speeds only a slight change of shape and as uniform as possible a circular shape. A further object of the invention is to create a rotor that may be employed as a chopper disk in a backscatter spectrometer and enable proper operation of the active element, especially the graphite crystals, placed on the rotor.

The problems of the invention are solved by a rotor comprising the totality of features according to the main claim, and by using a rotor according to the dependent claims. Advantageous embodiments of the rotor and the use of the rotor especially as a chopper disk are found in the respective claims.

### SUBJECT OF THE INVENTION

The rotor according to the invention is designed for high-speed operation in vacuum or rarified gases.

The specific geometry of the rotor advantageously causes a distinct reduction of stress and generally a uniform change of shape of the circumferential areas of the rotor when compared to traditional rotors.

On the one hand, the segmentation of the rotor and the cutouts within the rotor segments cause a desirable reduction of weight, on the other, the specific arrangement and design of the cutouts make it possible to optimize the change of shape during operation. This effect is especially obtained when high centrifugal forces at high peripheral speeds develop in the fringe area of the material.

The rotor according to the invention is especially designed to incorporate active elements and move them in a circular path, in the following referred to as the work circle. For instance, the rotor may be used as a chopper wheel in a backscatter spectrometer. When the circular path has a large radius of action, very large circumferential speeds may occur that regularly give rise to high strains due to the centrifugal force.

The rotor according to the invention comprises at least one rotor segment provided at the hub. A rotor segment within the scope of this refers to a part of a solid disk extending from the hub connection to the work circle, however, without having continuous rims. In a rotor with several segments, the segments are separated by cutouts facing outward. The segments are connected with one another in the hub area.

The rotor segment, itself, has at least one closed cutout provided such that the material defining the cutout is present in the form of spokes.

Spokes are generally understood to be rod-shaped parts of a wheel connecting a hub and a rim. Within the scope of this invention, however, the term spoke should not be limited to radial rod-shaped formations. In terms of this invention, spokes shall generally mean areas with continuous material extending from the hub to the outer peripheral boundary (work circle) of the rotor segment. The geometry of the cutout is based on a circle and has a continuous circumferential line. Typically, the geometry of the cutouts is oval or elliptical. The large and smooth rounding radii of each cutout minimize the stress on the edge and adjusts to the tension of the spokes.

An advantageous design of the rotor has two closed cutouts within a rotor segment, the rotor segment having especially a three-part structure. Closed cutouts in accordance with this invention explicitly do not comprise any holes drilled solely for the purpose of reducing the weight of the rotor. In contrast to a spoke-rimmed rotor, the rotor with one or more rotor segments according to the invention has no continuous spokes.

When operating a rotor with only one rotor segment, appropriate balancing with a counterweight is required. It is therefore more advantageous if the rotor is provided with at least two, three or more rotor segments that may be distributed in regular or irregular fashion around the hub.

An especially advantageous embodiment consists of a rotor in which the rotor segments are evenly distributed around the hub. It is critical that an imbalance does not occur in the arrangement. The individual rotor segments may thus be shaped either identically or differently.

Especially, a mirror-symmetric shape of the individual rotor segments has proven advantageous.

A special embodiment provides a rotor comprising rotor segments with a mirror-image three-part structure. The three spokes of a tri-rotor segment are thus to a large extent provided in parallel fashion. This embodiment causes advantageously mainly tension stress and only reduced bending stress to occur, the latter being especially critical.

As materials for the rotor, beside metals and their alloys, one can use ceramics, glass and other currently common materials, e.g. composite materials. This option is available especially because the bending strains of the rotor according to the invention, which also occurs at high rotational speeds, turn out to be noticeably lower than with comparable rotors known from the literature.

Based on a model of a disk with equal strain, the rotor according to the invention may feature an advantageous thickness profile, again resulting, depending on the selected geometry, in a further reduction of strain, and hence a more uniform change of shape during rotor operation. For instance, the rotor may have a radially tapering profile. In addition, the cutout and segment edges are advantageously further stress-optimized in terms of thickness in order to approximate an ideal disk with equal stress.

The advantages of the segmented rotor according to the invention are re-summarized below.
Compared to an equally large rotor in the form of a solid disk, it is significantly lighter, thereby reducing storage costs.
It has a more uniform change of shape at high rotational speeds in the area of circular-path relative to a rim/spoke rotor.
A larger rounding radius is possible, thus regularly reducing stress concentration.
The bending strains in the arcuate portions of the rims, as occur generally in a rim-spoked rotor, are eliminated with a segmented rotor.
The bending stress in the spokes of a spoke/rim rotor are noticeably reduced through redistribution in the segmented rotor, thus forming a distinct tensile-loaded shape, advantageously also allowing other rotor materials, such as ceramics or glass, to be used.

With the rotor according to the invention, the following improvements are realized over the prior art, especially in the fringe area of the load capacity:
At identical edge conditions, higher rotational speeds are possible;
At identical edge conditions, the safety factor against failure is noticeably increased;
The primary resonant frequence increases, whereby generally the bearing loads, especially those of magnetic bearings, are more easily controlled.

It thus becomes possible to create rotors for high-speed operation with a noticeably higher safety factor than previously possible, and/or noticeably higher rotational speeds may be obtained, without compromising safety against failure. This may also make it possible to use materials that for safety reasons were not previously considered as suitable.

An especially advantageous application of the rotor according to the invention is its operation in a backscatter spectrometer. Here, chopper disks with a diameter up to 1.5 m are needed, and they must withstand RPM's exceeding 4000, especially 5000, depending on their radius, in order to for example get a necessary circumferential speed above 300 m/s. For the future, however, disk diameters of up to 4 m and circumferential speeds up to 600 m/s are contemplated.

### SPECIFIC DESCRIPTION

In the following, the subject of the invention will be explained in more detail in reference to an example, including figures, without thereby limiting the subject matter of the invention.

The figures show the following:

FIG. 1 a chopper device of the backscatter spectrometer (RSSM) for the FRM-II reactor in Munich

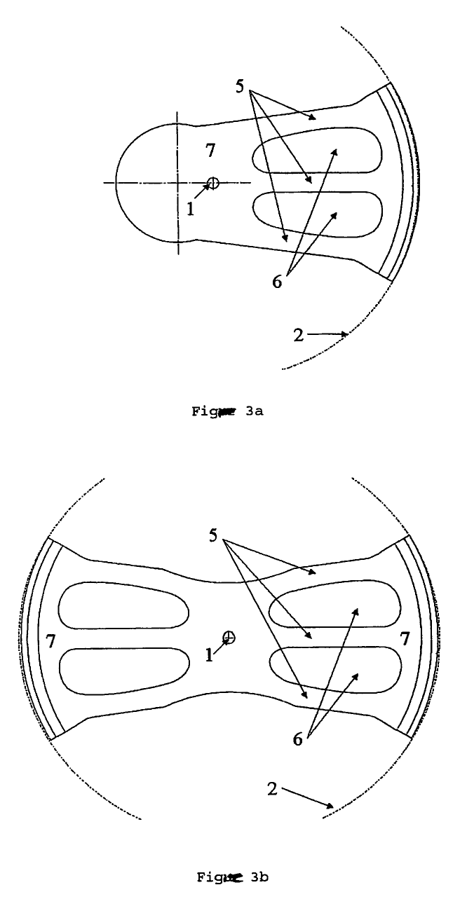

FIG. 2 a representation of known rotors, especially

a) a rotor as a solid disk,

b) a rotor as a rim-spoked wheel,

c) a segmented rotor without a rim.

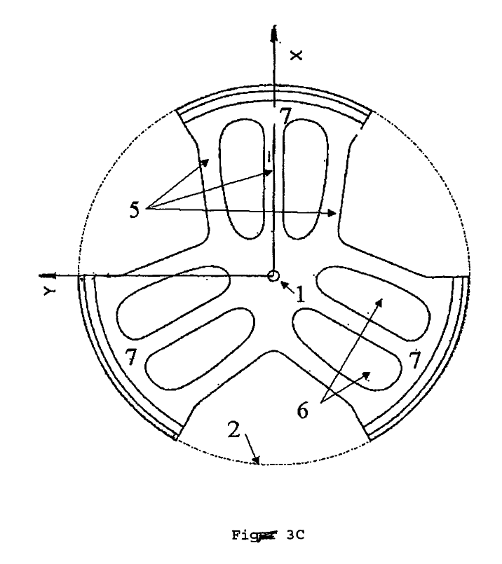

FIG. 3 embodiments of the rotor according to the invention with

a) a symmetric rotor segment,

b) two rotor segments provided angularly equispaced around a hub,

c) three rotor segments provided angularly equispaced around a hub.

The following references apply to the figures:

1 hub

2 imaginary circumference (work circle)

3 solid disk

4 rims

5 spokes

6 closed cutouts

7 rotor segment

8 cutouts open outward.

FIG. 1 shows the chopper device of the backscatter spectrometer (RSSM) for the FRM-II reactor in Munich. The solid chopper disk is clearly discernible. Graphite crystals are provided segmentally at its outer edge with a matching screen.

FIG. 2 is a schematic depiction of rotors, as known from the prior art. FIG. 2a) shows a rotor consisting of a solid material and as a solid disk 3. The rotor is generally carried on a hub 1. FIG. 2b) shows a typical rim/spoke wheel with a continuous rim 4 that is also a rotor. Instead of solid material, a plurality of individual closed cutouts 6 extending radially and symmetrically is provided. Between the cutouts, spokes are provided. The embodiment shown in FIG. 2c) may also be considered to be a rotor. This rotor has no closed rim. Cutouts 8 facing outward divide the rotor material into individual segments 7 that in this case, however, are kept together by a massive disk with a radius r.

In contrast, FIG. 3 shows different embodiments of the invention. The depicted rotor segments 7 consisting of a solid material feature at least two cutouts 6. The cutouts 6 are provided such that the remaining material of the rotor segment 7 has a structure of three spokes 5. Spokes refer to areas made of a continuous material of the hub 1 extending unitarily to the outer edge (work circle) 2 of the rotor segment. The rotor segments 7 shown in FIGS. 3a)-3c) also have mirror symmetry, whereby the axis of symmetry always goes through the hub.

FIG. 3a shows an example of the rotor according to the invention with only one rotor segment. Here, the rotor has a counterweight at the other side of the hub in order to balance the weight of the one rotor segment.

FIG. 3b shows a rotor with two rotor segments. These need not, however, be provided symmetrically around the hub. In the example shown in FIG. 3b), the individual rotor segments are provided evenly, i.e. offset 180° with respect to the hub. Since identical rotor segments are concerned, a counterweight is not needed.

This also applies to the rotor shown in FIG. 3c). The three identical rotor segments are provided around the hub, offset by 120° from one another.

1. A rotor for high-speed operation, characterized by at least one rotor segment (7) provided at a hub (1) and with at least one closed cutout (6) that to reduces stress that appears when operating the rotor.

2. A rotor according to claim 1 wherein the segment has at least two closed cutouts such that the material enclosing the cutouts is present in the form of three spokes (5).

3. A rotor according to claims 1 to 2 wherein the closed cutout has a continuous circumferential line.

4. A rotor according to any of claims 1 to 3 wherein the rotor segment (7) has mirror symmetry, and the axis of symmetry goes through the hub (1).

5. A rotor according to any of claims 1 to 4 wherein the spokes (5) of a rotor segment (7) are provided in a largely parallel fashion.

6. A rotor according to any of claims 1 to 5 wherein the rotor segment (7) is formed at its outer end as a segment of a circle.

7. A rotor according to any of claims 1 to 6, with at least three rotor segments (7).

8. A rotor according to any of claims 1 to 7 wherein the rotor segments (7) are provided in an evenly distributed manner around the hub (1).

9. A rotor according to any of claims 1 to 8 wherein the rotor segments (7) are identical to one another.

10. A rotor according to any of claims 1 to 9 wherein the rotor segments (7) are formed with a stress-optimized radial thickness profile.

11. A rotor according to any of claims 1 to 10 with a radius of action exceeding 500 mm, especially 1000 mm.

12. A rotor according to any of claims 1 to 11 with rotor segments (7) comprising metal, ceramics, glass or composite materials.

13. A rotor according to any of claims 1 to 12 suitable for circumferential speeds exceeding 300 m/s, especially exceeding 400 m/s.

14. Application of a rotor according to any of claims 1 to 13 for incorporation of at least one active element.

15. Application according to claim 14 as a chopper disk for incorporation of at least one graphite crystal for a backscatter spectrometer.
